(19) United States
(12) Patent Application Publication
(10) Pub. No.: US 2006/0069897 A1
(43) Pub. Date: Mar. 30, 2006

(54) Information processing device and information processing method

(76) Inventor: Satoshi Uchino, Ome-shi (JP)

Correspondence Address: DLA PIPER RUDNICK GRAY CARY US LLP, P. O. BOX 9271, RESTON, VA, 20195, US

(21) Appl. No.: 11/235,128

(22) Filed: Sep. 27, 2005

(30) Foreign Application Priority Data
Sep. 30, 2004 (JP) 2004-286762

(51) Int. Cl. G06F 13/28

(52) U.S. Cl. 711/168

(57) ABSTRACT

An information processing device having a plurality of processors, for carrying out processing on a data stream according to an aspect of the present invention includes a manager which reads a configuration file showing relations among a plurality of modules of processes to be executed on the data stream, allocates the plurality of modules to at least one of the plurality processors according to processing capacities of the respective processors, sets buffer information on the basis of information concerning the allocation of the plurality of modules, loads the modules and the buffer information, in the respective processors, and executes the loaded modules in the respective processors at a predetermined timing by use of the buffer information.

### CROSS-REFERENCE TO RELATED APPLICATIONS

This application is based upon and claims the benefit of priority from prior Japanese Patent Application No. 2004-286762, filed Sep. 30, 2004, the entire contents of which are incorporated herein by reference.

### BACKGROUND OF THE INVENTION

1. Field of the Invention

The present invention relates to an information processing device and an information processing method, and more specifically, to an information processing device and an information processing method for processing stream data in a multi processor system.

2. Description of the Related Art

Jpn. Pat. Appln. KOKAI Publication No. 2003-153168 proposes a stream processing device for processing stream data in which the freedom to control processing is improved. In this proposal, by changing the settings of matrix switches, system configurations may be changed freely. Therefore, processing methods are not changed by software.

In addition, Jpn. Pat. Appln. KOKAI Publication No. 2004-519043 proposes a software system for carrying out sequential image processing by developing a programmable platform of multiple distributed processors. This proposal is designed so as to process medical X-ray image sequences. In order to realize real time processing, high processing speed is required. Accordingly, control of electric power consumption is not considered.

### BRIEF SUMMARY OF THE INVENTION

An information processing device having a plurality of processors carries out real time processing on a data stream according to an aspect of the present invention. A configuration file is read. The configuration file shows relations among a plurality of modules in which processes are to be executed on the data stream. The plurality of modules are allocated to at least one processor according to processing capacities of the respective processors. Buffer information is set on the basis of information concerning the allocation of the plurality of modules to the processors. The modules and the buffer information are loaded to the respective processors. The loaded modules are executed in the respective processors at a predetermined timing by use of the buffer information. The present invention may be embodied as not only a device but also a method.

### BRIEF DESCRIPTION OF THE SEVERAL VIEWS OF THE DRAWING

FIG. 1 is a block diagram showing a schematic configuration of an information processing device according to one embodiment of the invention;

FIG. 2 is a diagram showing an example where a buffer area is shared as a shared memory area;

FIG. 3 is a diagram showing an example of a flow of data stream processing;

FIG. 4 is a flow chart showing the process of each module;

FIG. 5 is a flow chart showing a procedure of allocating a plurality of modules to processors;

FIG. 6 shows a specific example of a configuration file;

FIG. 7 shows a description example of a module configuration file;

FIG. 8 is a graph showing data dependency among modules;

FIG. 9 is a flow chart for explaining an example of allocating modules to processors in step S503;

FIG. 10 is a flow chart showing a detailed procedure for obtaining a buffer size and the number of banks;

FIG. 11 is a diagram showing an example of differences between a system configured by a high speed processor and a system configured by a low speed processor;

FIG. 12 is a diagram showing the use of buffers in the case of serial processing by one processor;

FIG. 13 is a diagram showing the use of buffers in the case of pipeline processing by two processors;

FIG. 14 shows setting information;

FIG. 15 is a flow chart showing procedures for starting execution of each processor;

FIG. 16 is a diagram showing a switching from a high speed mode to a low speed mode;

FIG. 17 is a diagram showing a switching from a low speed mode to a high speed mode;

FIG. 18 is a flow chart showing a basic flow in the case of dynamically switching an application configuration;

FIG. 19 is a flow chart for explaining a method of determining a configuration in each speed mode;

FIG. 20 is a flow chart showing procedures for determining allocation of modules to a processor in each speed mode;

FIG. 21 is a flow chart showing procedures for determining the execution order of each module, and the configuration of buffers;

FIG. 22 is a flow chart showing procedures concerning switching systems;

FIG. 23 is a flow chart showing switching procedures in the case of switching from a current speed mode to a lower speed mode; and

FIG. 24 is a flow chart showing switching procedures in the case of switching from a current speed mode to a higher speed mode.

### DETAILED DESCRIPTION OF THE INVENTION

Embodiments according to the present invention will be described in more details with reference to the accompanying drawings hereinafter.

FIG. 1 is a block diagram showing a schematic configuration of an information processing device according to one embodiment of the present invention.

As shown in FIG. 1, an information processing device according to one embodiment of the invention is of a shared memory type multi processor system in which first to N-th processors 11 to 13 share a shared memory 15 serving as a main memory. The shared memory 15 may be physically distributed to the processors 11 to 13, but must be logically shared by the respective processors 11 to 13. That is, the shared memory 15 may be a distributed shared memory. Further, an area of memory 15 to be shared by the processors 11 to 13 may not be the entire area of the shared memory 15, but an area to be used as a shared buffer area must be shared.

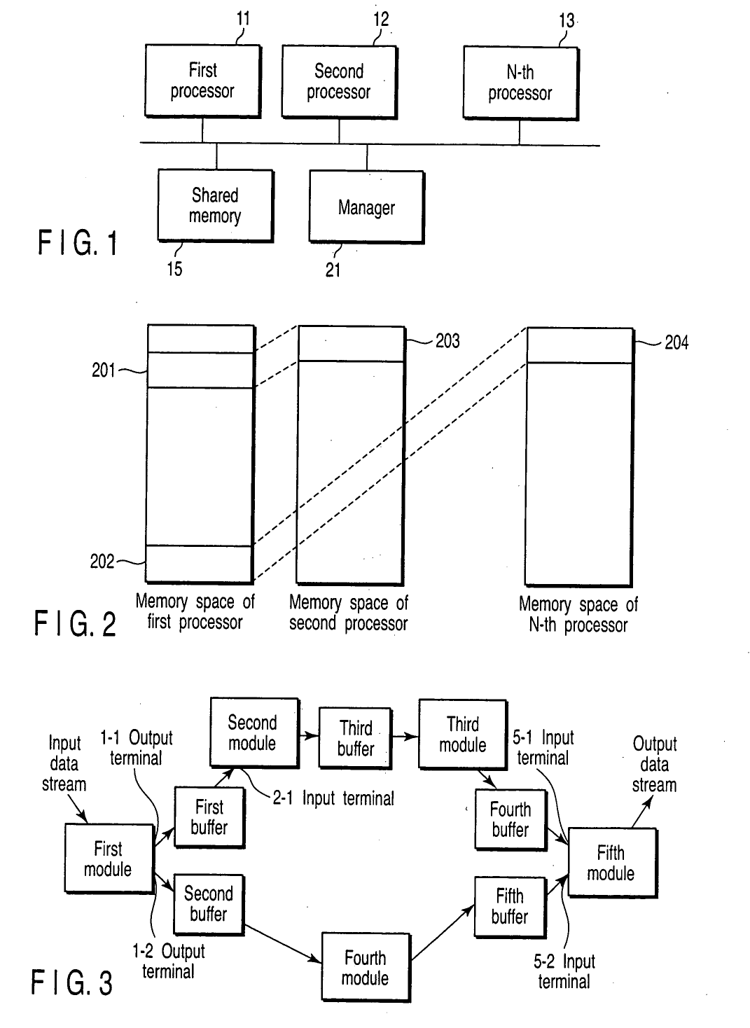

FIG. 2 is a diagram showing an example where an area that is used as a shared buffer area is shared as a memory area. As shown in FIG. 2, memory areas 201 and 203, and memory areas 202 and 204, respectively having the same contents are mapped in memory spaces in different processors. In this manner, by mapping the same contents to memory spaces of the respective processors, data is shared. As described previously, the memory spaces shown in FIG. 2 are logical spaces, and may be positioned at any portion physically.

An application illustrated herein is processing a data stream in real time, and is, as shown in FIG. 3, an application in which plural modules (first to fifth modules) carry out cooperative operations via common buffer memories (first to fifth buffers). In FIG. 3, each rectangle shows a module or a buffer, and each arrow shows the flow of the data stream. Input data is pipeline processed through plural modules, and output. In this case, each module is executed on a processor allocated by a manager 21 (details of the allocation to be described later herein).

As shown in FIG. 3, the data stream that is input to the first module is divided between two output terminals 1-1 and 1-2, for example, into video and audio after processing, and output. Date output from the output terminal 1-1 is input to the second module via the first buffer, where a predetermined process is executed. Data output from the second module is input to the third module via the third buffer, where a predetermined process is executed, and then input to the fifth module via the fourth buffer and via an input terminal 5-1 of the fifth module. On the other hand, data output from the output terminal 1-2 is input to the fourth module via the second buffer, where a predetermined process is executed, and then input to the fifth module via the fifth buffer and via an input terminal 5-2 of the fifth module. From the fifth module, the data stream is output after predetermined processes.

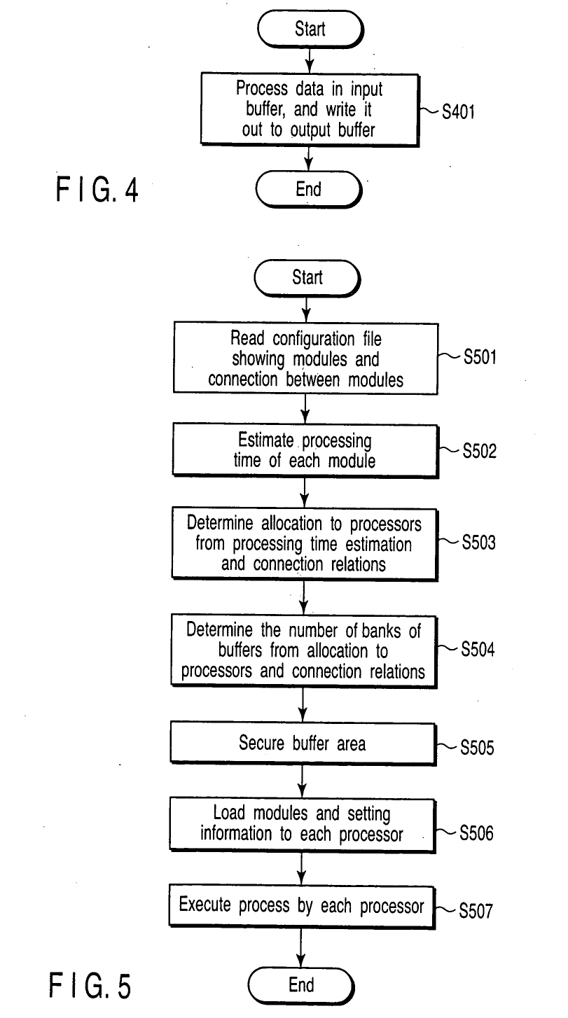

Each module as shown in FIG. 3 processes data in an input buffer, and writes data to an output buffer (See FIG. 4, step S401). Note that the number of input buffers and the number of output buffers may be one, or may be any number. For example, in FIG. 3, there are two output buffers for the first module. However, in the present embodiment, it is assumed that the most front stage module (for example, the first module in FIG. 3) inputs from a hardware device or the like instead of a buffer memory, and the most rear stage module (for example, the fifth module in FIG. 3) outputs to a hardware device or the like instead of a buffer memory. Further, it is assumed that buffers used between respective modules are shared among processors to which respective modules are arranged (for example, the memory areas 201 and 203 in FIG. 2).

In the embodiment, it is assumed that a video stream including video and audio is processed, and the stream is processed one frame at a time. Accordingly, it is assumed that each module processes the data of each frame within an inter-frame cycle.

FIG. 5 is a flow chart showing a procedure of allocating plural modules to processors.

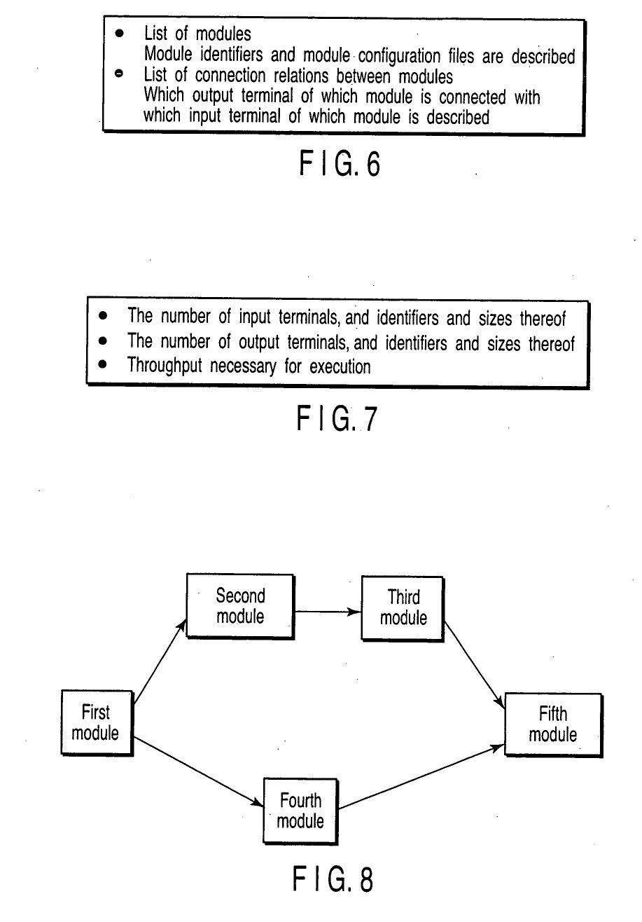

First, the manager 21 reads a configuration file showing modules and the connections between the modules (step S501). Note that the manager 21 may be omitted, and for example, a first processor 11 may read the configuration file instead. A concrete configuration example of the configuration file is shown in FIG. 6.

As shown in FIG. 6, the configuration file has a list of modules, and a list of connection relations between modules. In the list of modules, module identifiers and module configuration files are described, and in the list of connection relations between modules, which output terminal of which module is connected with which input terminal of which module is described. Specifically, in the example shown in FIG. 3, the first to fifth modules are described as the list of modules, and the list of connection relations, for example, describes that the output terminal 1-1 and the input terminal 2-1 are connected with respect to the first module and the second module. Note that, the module configuration files may be stored in a memory of the manager, or in a storage device or an external storage device (not shown) that is connected to a bus.

Further, a module configuration file, showing the configuration of each module, is shown in FIG. 7 for one module. The module configuration file describes the number of input terminals and the identifiers and sizes thereof, the number of output terminals and the identifiers and sizes thereof, and the throughput necessary for execution. Herein, identifiers are expressed as, for example, an input terminal 1, an input terminal 2 and the like. The size is expressed as X kb at maximum (X being a natural number) or the like.

Returning to FIG. 5, manager 21 estimates the processing time of each module (step S502). This processing time is obtained from the throughput necessary for execution described in the module configuration file shown in FIG. 7, and the processing capacity of the associated processor. The throughput necessary for execution may be expressed as, for example, a table of the operating frequency and processing time of a supposed processor.

Manager 21 actually allocates each module to each processor (step S503). At this moment, the data dependency among modules is shown in a graph (see FIG. 8). As shown in FIG. 8, the graph for the described embodiment includes branching and joining, but it does not include moving backward. For example, it does not include such a case as the result of the third module is used in the second module. This is because the generation of data that is sent backward will affect the processing result, and the cycle to be executed cannot be selected freely. In this case, it is necessary to handle the second module and the third module as one module, and accordingly, their configuration file as one module is created.

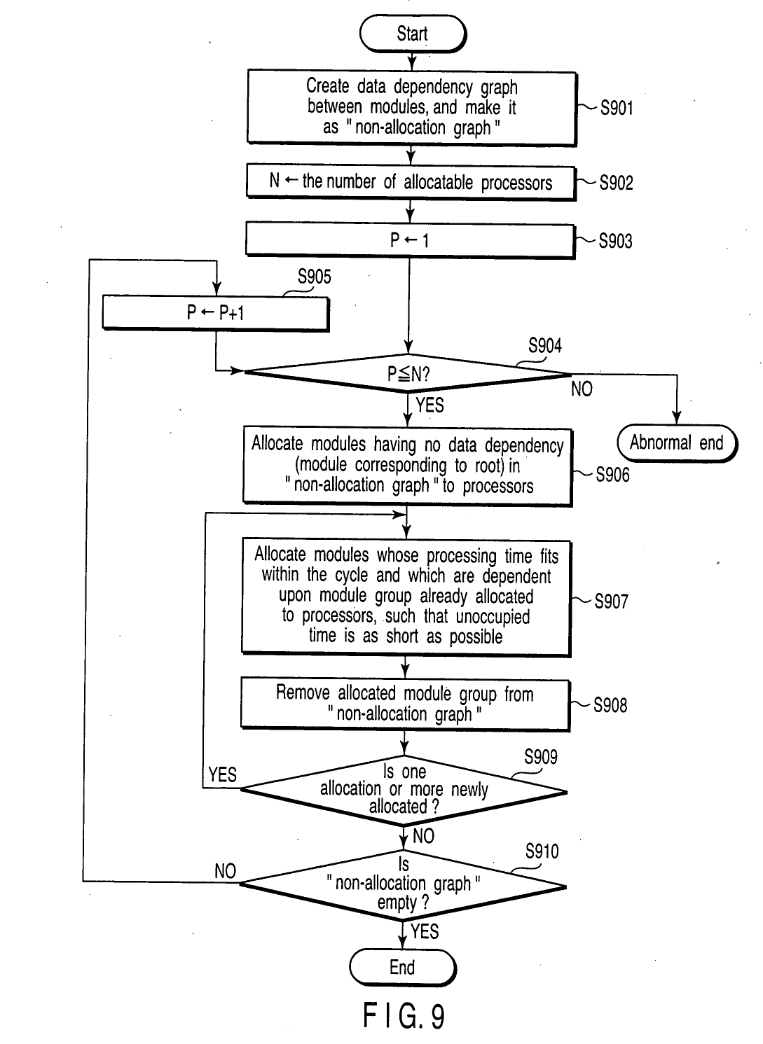

By reference to FIG. 9, an example of allocating modules to processors in step S503 will be explained.

First, a data dependency graph between modules is created as a “non-allocation graph”. FIG. 8 corresponds to this non-allocation graph. In FIG. 8, each rectangle shows a module, and the horizontal width of the rectangle shows processing time.

Next, the number of allocatable processors is substituted into a variable N (step S902). Then, 1 is substituted into the variable P (step S903). The variable P shows the processor numbers of allocatable processors, and 1 to N are valid in the embodiment.

In step S904, it is confirmed whether or not the variable P is in its valid range (namely, P≦N). In the case of P>N, there is no unallocated processor and execution is not available, and an abnormal end results. If the variable P is in its valid range, the procedure goes to step S906, where the process of the portion corresponding to the “root” of the “non-allocation graph” (namely, the module having no data dependency, i.e., the module which does not receive data from any other module) is allocated to one of unallocated processors (step S906). For example, if the first processor 11 is unallocated, the first module is allocated to the first processor 11. Then, at S907, if there is another process that is dependent on data only from a module already allocated, that process may be allocated to the first processor 11 (for example, in the example in FIG. 8, the second module or the fourth module are dependent only on the already allocated first module and therefore are allocated at this stage). In allocating modules to a processor within a processing cycle, the time which each processor is unoccupied during the processing cycle can be kept as short as possible. For this purpose, a simple method of allocating modules to a processor, for example in the order of length of the processing time, may be employed. Note that, in the example in FIG. 8, the third module depends upon the second module, and the fifth module depends upon the fourth module and the third module, respectively, and therefore, they cannot be allocated at this stage.

Thereafter, allocated modules are removed from the non-allocation graph (step S908). If one or more modules are newly allocated to a processor (in this case, the first, second and fourth modules have been allocated to the first processor 11) (step S909), there is a possibility that further modules may be allocated to the same processor, and therefore, the procedure goes back to the step S907. In this case, when, for example, the first, second and fourth modules are allocated to the first processor, it is determined whether or not the third module can be allocated to the same processor. Note that, since the fifth module depends on the third module, only the third module is allocated at this stage. If no more modules are newly allocated to the first processor, it is determined whether or not the non-allocation graph is empty (step S910), and if it is empty, the allocation of modules to the processors is complete. In step S910, if the non-allocation graph is not empty, P is incremented (step S905), and the procedures go back to the process at step S904 to allocate modules to the next processor.

In this manner, the modules are allocated to the processors.

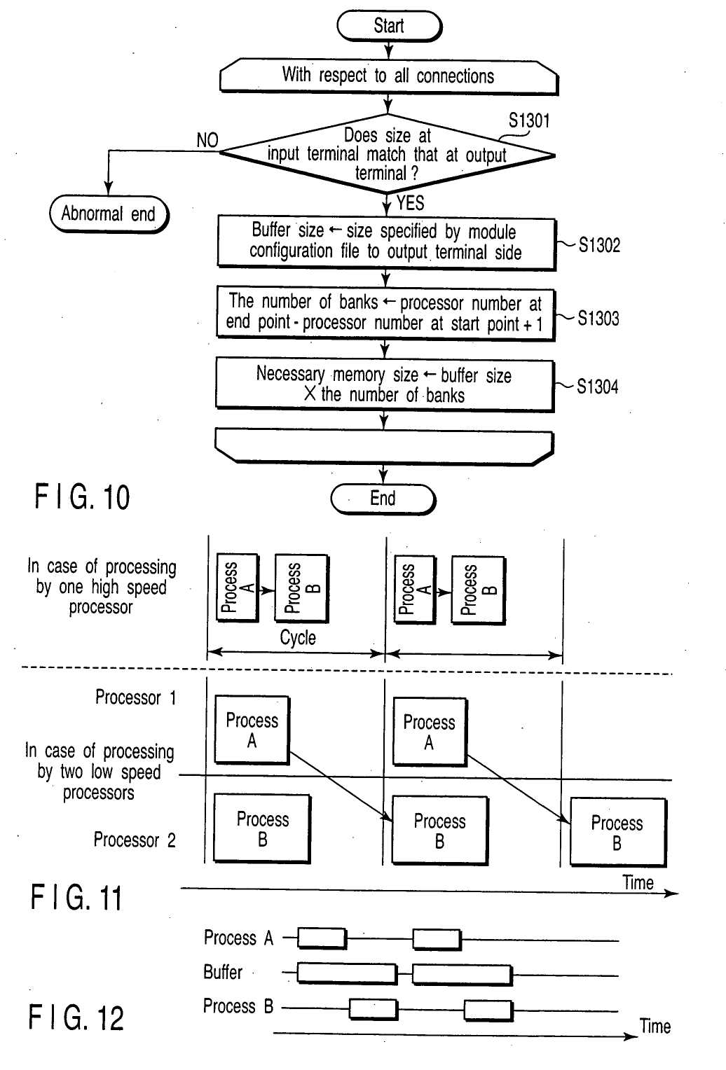

Now back to the flow chart in FIG. 5, when manager 21 has allocated the modules to the processors, the number of banks of buffers needed between modules is set based on the allocation of modules to processors and the connection relations between the modules (step S504). The detailed procedure for obtaining the buffer size and the number of banks is shown in FIG. 10.

In FIG. 10, it is determined whether or not the size at the input terminal of a subsequent module matches that at the output terminal of the module for each pair of modules (step S1301), and if it does not match, an abnormal end results. If it matches, the buffer size is set to the size specified by the module configuration file for the module with the output terminal (step S1302). For example, in the example in FIG. 3, the size of the output terminal 1-1 of the first terminal must match that of the input terminal 2-1 of the second module in the module configuration file. The number of buffers corresponds to the number of items in the list of connection relations. For example, in the example in FIG. 3, there are five connections in total including the one from the first module to the second module, the one from the first module to the fourth module, the one from the second module to third module, the one from the third module to the fifth module, and the one from the fourth module to the fifth module. It is necessary to secure buffers for the respective connections (namely, the first buffer to the fifth buffer in FIG. 3). In addition, the buffer size described in the module configuration file shown in FIG. 7 is used. The number of banks between each pair of a first module and a second module dependent on the first module is set to (the processor number of the processor which processes the second module−the processor number of the processor which processes the first module+1) (step S1303). Then, the product of the buffer size and the number of banks is set as the memory size.

In the above processing, the step S1303 to obtain the number of banks will be explained in detail. To simplify the explanation, a case is supposed where two processes (for example, the second module and the third module in FIG. 3) are assigned to processors in two manners. FIG. 11 shows an example of differences between a system configured for a high speed processor and a system configured for two low speed processors. The high speed processor can execute a process A in the second module and a process B in the third module within one cycle, and therefore, serial processing is executed by one processor. On the other hand, the slow speed processor cannot execute the process A and the process B within one cycle, and therefore, pipeline processing is carried out by a combination of two processors. Herein, data from the process A is processed by the process B in the next cycle.

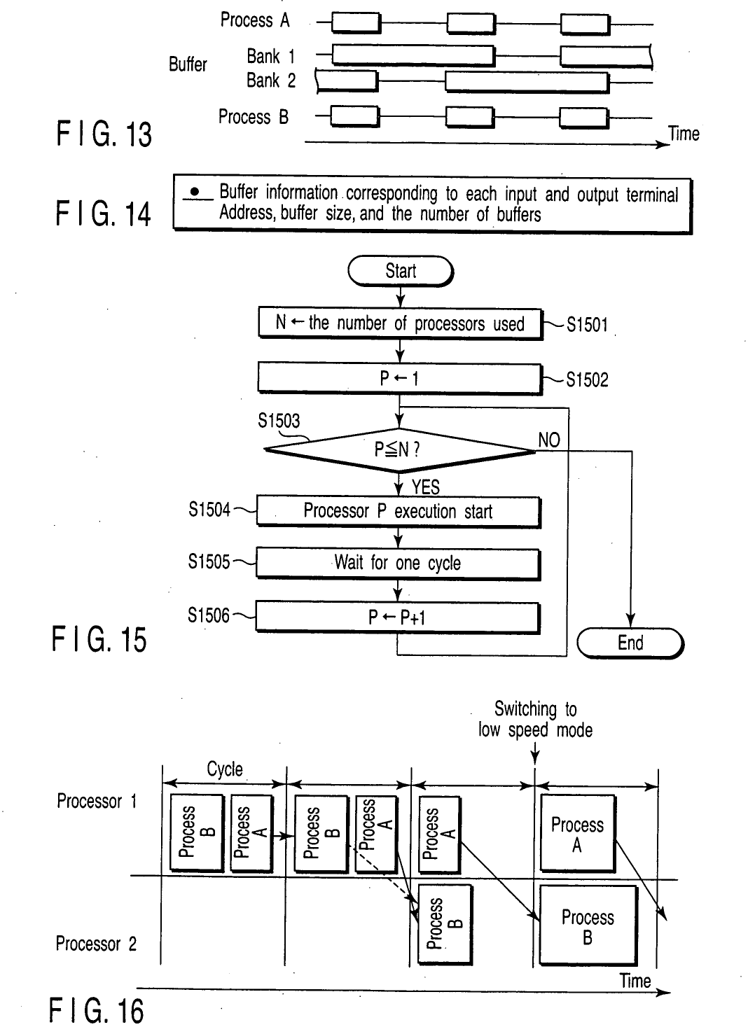

In the two cases, the necessary number of banks of necessary buffer memories is different. FIG. 12 is a diagram showing the use of buffers in the case of serial processing by one processor. In FIG. 12, execution of the process A and the process B, and the use of buffers are shown by rectangles. Since writing from the process A and reading from the process B are performed at different times, one buffer is sufficient. On the other hand, FIG. 13 is a diagram showing the use of buffers in the case of pipeline processing by two processors. Execution of the process A and the process B, and the use of buffers are shown by rectangles. In this case, since writing for the process A, and reading for the process B of the data from the previous cycle are carried out in parallel, two buffers are required. In general, the number of banks depends on the number of cycles from the cycle in which data is written to the cycle in which data is read. Accordingly, the number of necessary buffers between a first module and a second module dependent on the first module can be obtained by (the processor number of the processor which processes the second module−the processor number of the processor which processes the first module+1).

Now back to the flow chart in FIG. 5, when the number of banks is set, a buffer area according to the buffer size set in step S1302 is secured (step S505). Note that the memory size necessary for each buffer is, as shown in step S1304, the product of the buffer size and the number of banks.

Then, modules and setting information are loaded in each processor (step S506), and the allocated process is executed by each processor (step S507). In this case, the setting information is buffer information corresponding to each input and output terminal as shown in FIG. 14, and is information including an address, a buffer size and the number of buffers.

Then, modules and setting information are loaded to each processor (step S506), and each module sets access procedures to buffers on the basis of this setting information.

Finally, the execution starts at each processor (step S507). Herein, each processor starts its execution with a delay of one cycle from execution by the previous processor on the transferred data. In the process in step S507, notification of the start of execution of each processor is made by the manager 21 (or one processor among the first to N-th processors), and after the execution by each processor starts, the execution is carried out independently by each processor. The procedure thereof is shown in FIG. 15.

First, as an initialization condition, the number N of processors to be used is set (step S1501), and 1 is set to the variable P (step S1502). Until P exceeds N, steps S1504 to S1506 are executed (step S1503). Note that, when P exceeds N, the processing ends.

If P is N or smaller than N in step S1503, the processor P executes (step S1504), and waits for one cycle (step S1505). Then, as P=P+1 (step S1506), this processing is continued until P>N.

With this procedure, the same application software can be executed on processors of different processing capacities. The processing occurs in each of a plurality of processors one cycle delayed from the previous processor on the transferred data. Therefore, although the turn-around time (frequency) increases, the throughput (real time property) can be maintained. For example, according to the above method, a system that operates on a multi processor system configured with four high speed units can also be operated on a multi processor system configured with eight low speed units, without modification. Consequently, flexibility in the selection of the number of processors and the processing capacities thereof is increased. Application development may be freely made independent of processor configurations.

In the above embodiment, operations continue with a predetermined configuration. However, in the following embodiment, application configurations are dynamically changed according to system loads. An objective of the embodiment below is to provide a multi processor system where processor operating frequencies are dynamically changed, plural applications are executed on processors, and the use ratios of processors appropriately changes according thereto.

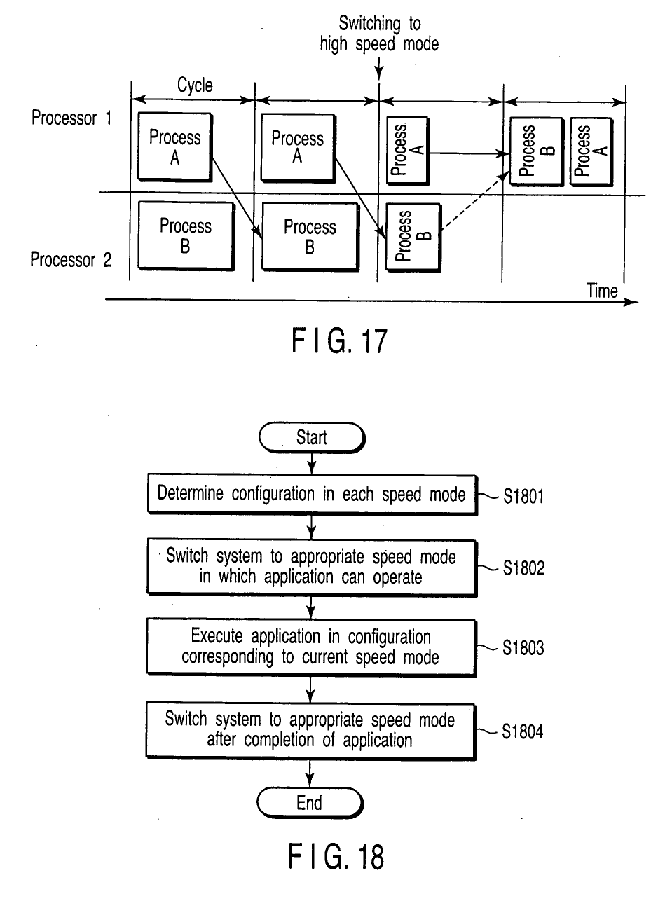

For use of explanation, two modes, i.e., a high speed mode and a low speed mode, are supposed. A change from the high speed mode to the low speed mode is shown in FIG. 16, and a change from the low speed mode to the high speed mode is shown in FIG. 17. An example where two processes, process A and process B, are executed on stream data is shown.

It is assumed that in the low speed mode, two processors are used, and the data stream is processed in two cycles. In order not to disturb the stream, it is necessary to process the stream with the same number of cycles (two cycles in this example) also in the high speed mode, and accordingly, the output of process A is processed by process B in the next cycle. By processing in the order of process B first, and process A second, the number of banks of buffers can be reduced by one. In the examples shown in FIGS. 16 and 17, execution is available with the number of bank being one in the high speed mode.

A basic procedure in the case of dynamically changing an application configuration is shown in FIG. 18.

First, configuration information is determined to each speed mode (step S1801). Next, the system is switched to an appropriate speed mode at which the application may work (step S1802).

In the configuration corresponding to the current speed mode, the application is executed (step S1803). After completion of the application, the system is switched to an appropriate speed mode (step S1804).

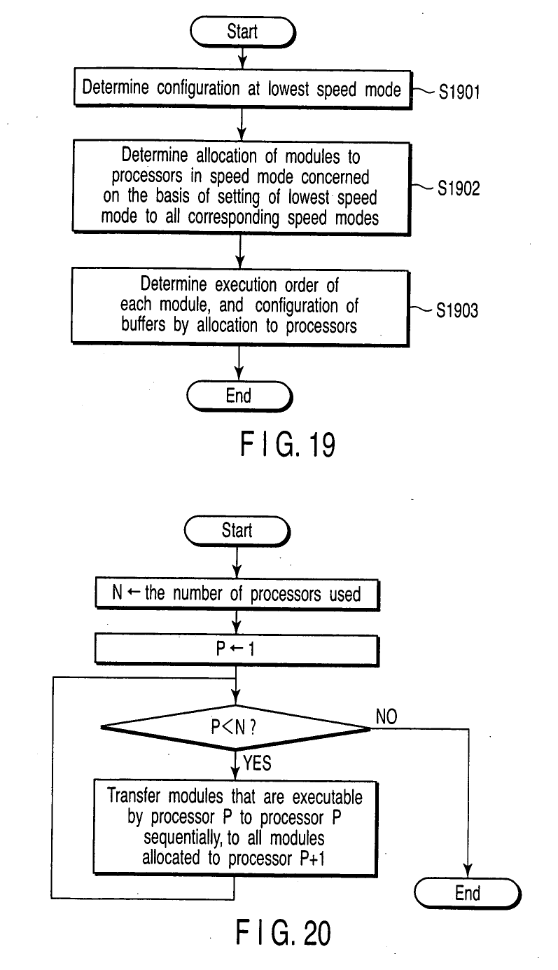

Through the above procedures, it is possible to dynamically switch the application configuration. In the above flow, the method of determining a configuration in each speed mode is explained by reference to FIG. 19.

First, the configuration is determined in the lowest speed mode (step S1901). This procedure is the same as the procedure in the embodiment explained by reference to FIG. 5, and therefore, a detailed explanation is omitted. Next, allocation of modules to processors in each speed mode is determined (step S1902). This procedure is carried out, as shown in FIG. 20, by sequentially transferring all modules that are allocated to processor P+1 that can be executed by processor P to processor P.

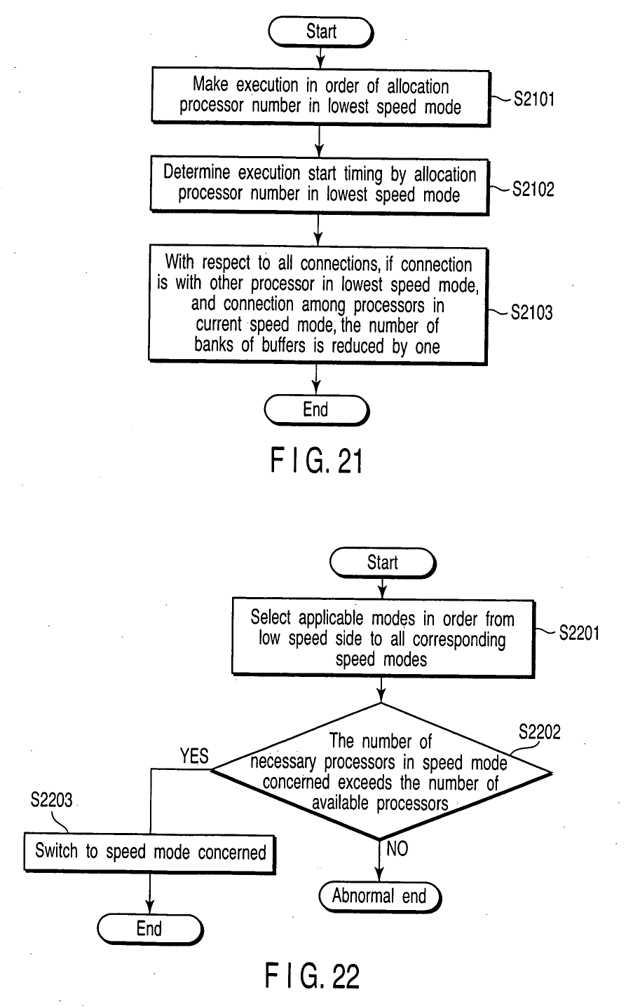

Then, the execution order of modules, and the configuration of buffers are determined based on the allocation of modules to the processors (step S1903). This procedure is shown in FIG. 21.

First, the modules are executed in the order of the allocated processor number in the lowest speed mode (step S2101). At this moment, the execution start timing is determined by the allotted processor number in the lowest speed mode (step S2102). With respect to all the connections between modules, if the connection is with another processor in the lowest speed mode, and both modules are associated with the same processor in the current speed mode, the number of banks of buffers is reduced by one (step S2103).

Then, in step S1802 in FIG. 18, the system is switched to the speed mode suitable for activating the application on the basis of the configuration information obtained in the above manner. The specific procedure concerning switching systems is shown in FIG. 22.

To all the corresponding speed modes, applicable modes are selected in order from the low speed side (step S2201). If the number of necessary processors in the mode concerned exceeds the number of available processors (step S2202), an abnormal end results. In this case, the application to be operated cannot be executed. In the step S2202, if the number of necessary processors in the mode concerned is the number of available processors or below, the processor mode is switched to the speed mode concerned (step S2203).

The number of necessary processors in step S2202 is the total number of processors now in operation, or processors necessary to execute all the applications to be activated from now, and is same as the number of processors estimated in step S1902 for respective applications.

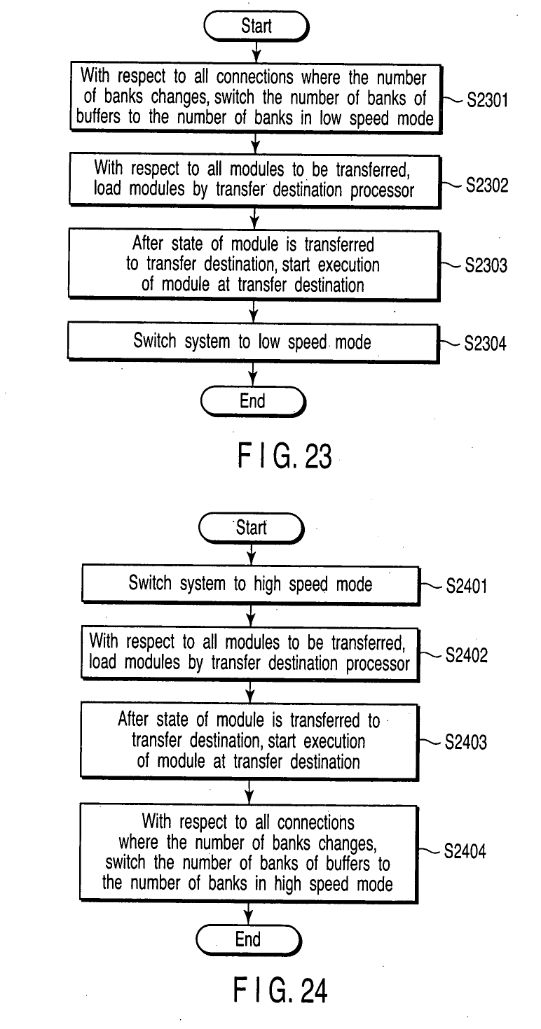

In the flow as shown above, the switching procedure, when switching from the current speed mode to a lower speed mode as shown in FIG. 16, is shown in FIG. 23, and the switching procedure, when switching from the current speed mode to a higher speed mode as shown in FIG. 17, is shown in FIG. 24.

In the process shown in FIG. 23, first, the number of banks of buffers is switched to the number of banks in the low speed mode (step S2301) with respect to all the connections where the number of banks changes. Namely, in the case where the number of processors increases when changing to the low speed mode, the number of banks is increased accordingly. Next, with respect to all the modules to be transferred, modules are loaded to the transfer destination processor (processor 2) (step S2302). In FIG. 16, the process of loading the process B to the processor 2 corresponds to this step. After the module (process B) is transferred to the transfer destination (processor 2), and after the execution of the module (process B) is started at the transfer destination (processor 2) (step S2303), the system is switched to the low speed mode (step S2304).

Further, in the process shown in FIG. 24, the system is switched to the high speed mode (step S2401). Next, with respect to all the modules (process B) to be transferred, modules are loaded by the transfer destination processor (processor 1) (step S2402). The state of the module (process B) is transferred to the transfer destination (processor 1), and the execution of the module (process B) is started at the transfer destination (processor 1) (step S2403). With respect to all the connections where the number of banks change, the number of banks of buffers is switched to the number of banks in the high speed mode (step S2404). Specifically, the number of banks of buffers between the process A and the process B is reduced by one.

In FIGS. 16 and 17, it is not necessary to complete all the steps (process A and process B) within one cycle at the moment of switching. However, it is necessary to complete each of the process A and the process B within one cycle.

As described heretofore, according to the embodiments of the invention, by switching speed modes (operating frequencies) of processors according to system loads, it is possible to appropriately control electric power consumption while keeping the real time property of operational applications.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A manager for an information processing system having a plurality of processors, for carrying out processing on a data stream, wherein the manager:
reads a configuration file showing relations among a plurality of modules of processes to be executed on the data stream, and allocates the plurality of modules to at least one of the plurality of processors according to processing capacities of the respective processors;
sets buffer information on the basis of information concerning the allocation of the plurality of modules to the processors;
loads the modules and the buffer information in the respective processors; and
causes the loaded modules to be executed in the respective processors at a predetermined timing by use of the buffer information.

2. An information processing device according to claim 1, wherein, when all the processes on the data stream are not processed in a real time manner, the manager allots modules to additional processors, and processes the modules in separate processors.

3. An information processing device according to claim 2, wherein, when a first module is executed on a first processor and a second module is executed on a second processor, the second processor executes the second module the cycle after the first processor executes the first module.

4. An information processing device according to claim 1, wherein the configuration file includes a list of plural modules, and a list of connection relations among the modules.

5. An information processing device according to claim 4, wherein the list of modules has meta information which enables estimation of a processing time for each module based on processing capacities of the processors.

6. An information processing device according to claim 1, wherein the buffer information is set according to the time from the moment when information can first be written into a buffer memory to the moment when the information can no longer be read therefrom.

7. An information processing device according to claim 1, wherein the manager, upon reading the configuration file, creates a data dependency graph among modules, and allocates modules having no data dependency sequentially to allocatable processors on the basis of the data dependency graph.

8. An information processing device according to claim 1, wherein the processing capacities of the processors are variable, and
when loads of the information processing device fluctuate during execution of modules by the processors, the modules are reallocated to the processors according to processing capacities of the processors, and thereby application configurations are switched dynamically.

9. An information processing device according to claim 8, wherein operating frequencies of the processors are switchable, and the operating frequencies of the processors are switched according to loads of the information processing device.

10. An information processing method which is applied to an information processing device having a plurality of processors, the information processing device carrying out processing on a data stream, the method comprising:
reading a configuration file showing the relations among a plurality of modules of processes to be executed on the data stream, and allocating the plurality of modules to at least one of the plurality of processors according to processing capacities of the respective processors;
setting buffer information on the basis of information concerning the allocation of the plurality of modules to the processors;
loading the modules and the set buffer information to the respective processors; and
executing the loaded modules in the respective processors at a predetermined timing by use of the loaded buffer information.

11. An information processing method according to claim 10, wherein
the processing capacities of the processors are changeable, and the method further comprises:
when loads of the information processing device fluctuate during execution of modules by the processors, reallocating the modules to processors according to processing capacities of the processors.
